(19) United States
(12) Patent Application Publication
(10) Pub. No.: US 2002/0156650 A1
(43) Pub. Date: Oct. 24, 2002

(54) Secure distribution of digital healthcare data using an offsite internet file server

(76) Inventors: Michael V. Klein, San Marino, CA (US); Barbara J. Klein, San Marino, CA (US)

Correspondence Address: Michael Vincent Klein, 1488 Kensington Road, San Marino, CA, 91108, US

(21) Appl. No.: 09/788,049

(22) Filed: Feb. 17, 2001

(51) Int. Cl. G06F 17/60

(52) U.S. Cl. 705/2; 705/3

(57) ABSTRACT

A system for secure distribution of digital healthcare data using an offsite internet file server. The inventive device includes a healthcare device which generates a set of digital medical data files which are securely transmitted over the internet to an offsite internet file server which provides the ability to upload and download the files from a requesting web client using open standard internet protocols.

### CROSS-REFERENCE TO RELATED APPLICATIONS

Not applicable.

### STATEMENT REGARDING FEDERALLY SPONSORED RESEARCH OR DEVELOPMENT.

Not applicable.

### REFERENCE TO A “MICROFICHE APPENDIX”

Not applicable.

### BACKGROUND OF THE INVENTION—FIELD OF THE INVENTION

The present invention pertains to the field of healthcare devices. The present invention relates to a system for the transmission of medical data and more particularly to a system for the secure distribution of digital healthcare data for offsite review using an offsite internet file server.

### BACKGROUND OF THE INVENTION—DESCRIPTION OF RELATED ART

A variety of devices that allow for remote access to medical information pertaining to patients in hospitals and clinics have been in use for years. For example, a computed tomography scanner is commonly used in hospitals and clinics to obtain cross-sectional diagnostic images of a body part. Other routine diagnostic devices include magnetic resonance imaging, ultrasound, conventional and digital radiography and fluoroscopy, nuclear medicine and angiography. Other non-radiographic medical information may be captured in digital format for later review. Examples include heart rate, blood pressure, electrocardiogram, sound recordings of the heart and lungs, images captured during an endoscopic, fundoscopic or intraoperative procedure, or scanned or digitized medical documents or reports. Digital images can be captured of pathologic specimens, preparations and slides. Such devices are hereinafter referred to as healthcare devices. Digital data files created from the output of healthcare devices are hereinafter referred to as digital healthcare data or digital medical data files. The use of such files for subsequent electronic or digital offsite review is commonly referred to as the practice of telemedicine.

Healthcare devices commonly provide an access mechanism for transferring digital medical data files contained therein to a computer system. Such an access mechanism usually facilitates distribution of digital medical data files by taking advantage of the display and storage capabilities of a computer system. A proprietary interface designed specially for a particular healthcare device including specialized software that executes on a computer system is typically used. Digital medical data files can be can reside on the same computer or be transferred by a local area network connection to a computer containing file server software. File server software allows for subsequent distribution of digital medical data files to other computers via a local area network, direct dial-up connection or via the internet, if an internet file server software and an appropriate internet connection is present.

The main problem inherent in the design of conventional telemedicine systems is that there are significant limitations to providing flexible and secure access to a file server for both uploading and downloading files. An on-premise file server usually requires that the healthcare device and computer system controlling the distribution of digital medical data files be directly connected to each other or have a local area network connection. Furthermore, “internet access” usually only refers to offsite downloading and review of files. Conventional telemedicine systems do not provide the flexibility of uploading data files over a secure internet connection from an originating healthcare device to a on- or off-site file server from which the digital medical data file can be downloaded via a secure internet connection.

Unfortunately, prior methods of accessing digital healthcare device data are usually not well suited to small hospital, clinic or office environments, where financial and manpower resources are limited. A dedicated local networked computer system and file server with proprietary interfaces may not be available. The costs associated with equipping each location with specialized hardware for an internet file server computer system is usually prohibitively expensive. Moreover, the cost of providing the technical expertise to setup and maintain such internet file servers may also be prohibitively expensive.

Environments where healthcare devices are in physically separate locations, such as clinics in different locations throughout a region or a satellite clinic associated with a primary clinic, but whose resultant medical information is reviewed by professionals at single or multiple locations, would necessitate duplicating a file server system at each site or provide other usually expensive or technically complicated networking options, such as a Virtual Private Network.

An important limitation in the design of prior methods of distributing digital healthcare device data over the internet is that there usually are significant requirements regarding the internet file server used. Most hosted web services provide a very restrictive environment for executing custom or propriety code beyond common technologies, such as HyperText Markup Language (HTML), Java, JavaScript, or other web-based technologies. Prior method file transfer mechanisms are frequently based on propriety and custom file server technologies requiring the server to execute code in a manner not generally available with low-cost hosted web services. In addition, the web server operating system platform frequently is restrictive. Prior methods for secure internet distribution of digital healthcare data is generally not feasible on a low-cost web hosting solution.

Prior methods for accessing digital healthcare data are frequently limited by restrictions regarding the data format that either is utilized. The original file format may need to be converted to other formats, frequently with the loss of information or the ability to manipulate the data. For example, the conversion of a full dataset generated by a medical imaging device to a more generic format, such as the web browser-viewable JPEG format, usually results in the loss of both image fidelity and thus diagnostic value, as well as the loss of the image manipulation features inherent in the native format.

While prior healthcare and telemedicine devices may be suitable for the particular purpose to which they address, such limitations in providing access to digital medical data files in certain environments may severely limit the utility of prior healthcare devices.

In view of the foregoing disadvantages inherent in the known types of telemedicine systems now present in the prior art, the internet file server according to the present invention substantially departs from the conventional concepts and designs of the prior art, and in so doing provides an apparatus primarily developed for the purpose of providing universally accessibility to digital healthcare data files.

### BRIEF SUMMARY OF THE INVENTION

As explained in detail below, the primary object of the present invention is to provide secure access to the digital medical data files created by healthcare devices by the use of an internet file server located at a location separate from the original healthcare device producing the digital information file. This invention comprises: a diagnostic healthcare device which produces medical data, a file upload workstation computer with transmit capabilities, an internet file server with receive and transmit capabilities, and a file download workstation computer with retrieve and display capabilities. The diagnostic healthcare device comprises a medical modality device, a medical data processor and a medical data output file. The file upload workstation comprises a computer with a local network connection, local data storage, file processing and encryption software, web browser software and an internet connection. The internet file server comprises a computer with an internet connection, web server file upload and download software and server data storage. The file download workstation comprises a computer with an internet connection, web browser software, local data storage, file processing and decryption software and data viewing software.

In one embodiment, the invention includes a diagnostic healthcare device consisting of a medical modality outputting data to a digital medical data file. The diagnostic healthcare device is communicatively coupled to a local client machine functioning as a local file upload workstation which receives or retrieves the digital medical data file. The file upload workstation is communicatively coupled to a remote or offsite internet file server over the public internet utilizing a web browser interface or equivalent software. The internet file server and website is located at an “offsite hosted” environment. An “offsite” environment is one in which the file server and associated website are located, managed and physically maintained at a location separate from the diagnostic healthcare device and which does not have a direct or local network connection to the diagnostic healthcare device. A “hosted” environment is one in which the file server and associated website are managed and physically maintained at a location operated by a third party whose primary business is providing these services to a multiplicity of clients on one or several servers. The local file upload workstation machine uploads the digital medical data files to a offsite internet file server either through a conventional web browser or via specialized software incorporating similar communication protocols via the public internet. The web server on the offsite internet file server is accessed via a web browser or equivalent program executed on a remote client machine functioning as a remote file upload workstation communicatively connected to the internet file server via the public internet. Through the web browser or third-party software, the client machine can view the digital medical data files from within a browser or to download the digital medical data file to a local hard drive for subsequent review.

An object of the present invention is to provide a secure method of distributing digital healthcare data.

Another object of the present invention is to provide a method of distributing digital healthcare data without modifying the format or quality of the original file.

Another object of the present invention is to provide multiple levels of optional security and encryption during the transfer of digital healthcare data, including file and transmission encryption techniques.

Yet another object of the present invention is to make the medical information contained in healthcare devices widely accessible and available sooner in comparison to prior to systems that require onsite file servers.

A further object of the present invention is to reduce the cost of telemedicine by eliminating the requirement of having a local network for accessing medical information from healthcare devices.

Another object of the present invention is to reduce the cost of telemedicine by eliminating the requirement of having a local propriety file server for accessing medical information from healthcare devices.

Another object of the present invention if to provide a system which can be installed within the restrictive operating environment found in most low-cost web hosting packages.

Yet another object of the present invention is to reduce the cost of telemedicine by eliminating the requirement of a dedicated communications link to retrieve a digital medical data file.

Another object of the present invention is to reduce the cost of telemedicine by eliminating the requirement of having a specialized computer for accessing medical information from healthcare devices.

Still yet another object of the invention is to minimize file maintenance requirements on the internet web server and local computers.

Another object of the invention is to improve availability and reliability of the telemedicine system by using a third-party professionally managed and maintained internet website hosting service.

Other objects and advantages of the present invention will become apparent from the following descriptions, taken in connection with the accompanying drawings, wherein, by way of illustration and example, an embodiment of the present invention is disclosed and it is intended that these objects and advantages are within the scope of the present invention.

### BRIEF DESCRIPTION OF THE SEVERAL VIEWS OF THE DRAWING

The present invention is described with respect to particular exemplary embodiments thereof and reference is accordingly made to the drawings in which:

FIG. 1 is a diagram of the system architecture for secure distribution of digital healthcare data using an offsite internet file server;

FIG. 2 illustrates a diagnostic healthcare device which may consist of one of several different modalities;

FIG. 3 illustrates a computer file upload workstation which coordinates the uploading of medical data files to an internet file server;

FIG. 4 illustrates an internet file server which accepts both medical data file uploads and downloads over an internet connection;

FIG. 5 illustrates web server file upload software located on an internet file server;

FIG. 6 illustrates web server file download software located on an internet file server;

FIG. 7 illustrates a computer file download workstation which coordinates the downloading of medical data files from an internet file server.

### DETAILED DESCRIPTION OF THE INVENTION

In the following detailed description, references are mode to the accompanying drawings which illustrate specific embodiments in which the invention may be practiced. Electrical, mechanical and structural changes may be made to the embodiments without departing from the spirit and scope of the present invention. The following detailed description is, therefore, not limited in its application to the details of construction and to the arrangements of the components set forth in the following description or illustrated in the drawings. Also, it is to be understood that the phraseology and terminology employed herein are for the purpose of the description and should not be regarded as limiting.

Turning now descriptively to the drawings, in which similar reference characters denote similar elements throughout the several views, the attached figures illustrate a system providing universal secure access to digital medical data files by means of a hosted or offsite internet file server using open standard network protocols.

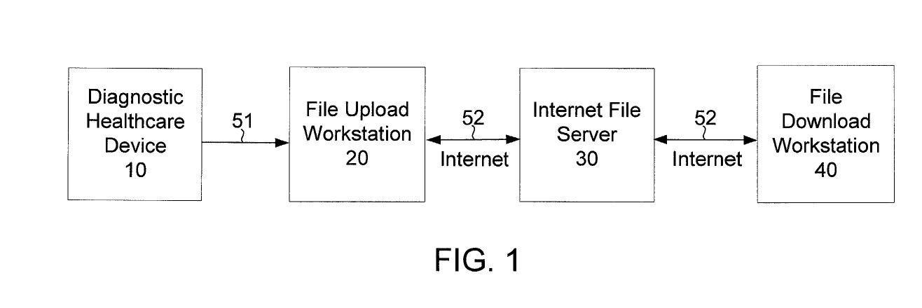

FIG. 1 is a block diagram illustrating and overview of an embodiment of a medical communication system incorporating a diagnostic healthcare device 10 which is accessible to a computer or local client machine functioning as a file upload workstation 20 via a direct connection or local area network 51 using open standard network protocols. The digital medical data file from the diagnostic healthcare device 10 is transferred to file upload workstation 20 which then uploads the digital medical information file by exchanging messages with a remote or offsite internet file server 30 using open standard protocols on the public internet communication network 52. The internet file server 30 handles the file transfer commands received via the internet 52 that specify a predetermined Universal Resource Locator (URL) specific for the site of origin of the digital medical data file, such as the name of a hospital, office or clinic, or the type of medical information device 10, such as ultrasound or computed tomography. The digital medical data files may be available in either in an unmodified form or processed by the internet file server 30 into HTML or other web-related format. A computer or remote client machine functioning as a file download workstation 40 can access the website on the internet file server 30 via the public internet 52. The digital medical data file can be downloaded from the internet file server 30 to the file download workstation 40 by exchanging messages using open standard protocols on the public internet communication network 52.

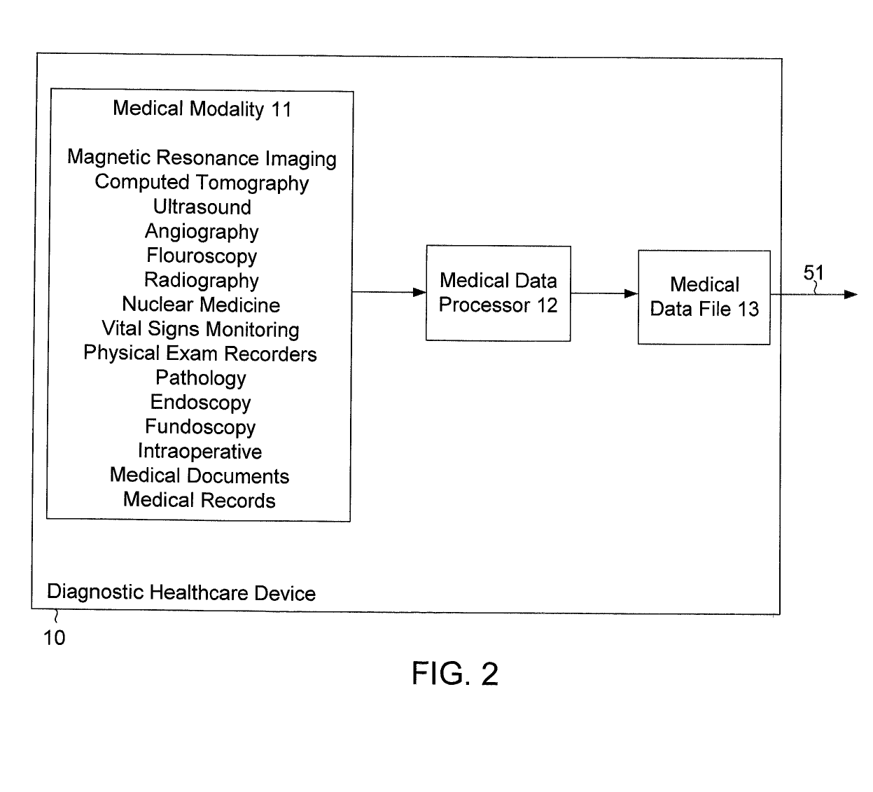

FIG. 2 illustrates a diagnostic healthcare device 10 in block diagram form. The medical modality device 11 represents the mechanisms necessary to perform the device-specific medical function of the healthcare device 10. Such mechanisms may include chemical, mechanical, electromagnetic, optical, electrical, or electronic mechanisms or any combination thereof. The medical data processor 12 includes mechanisms for digitizing, processing and storing obtained data from an analog medical modality device 11 and for processing and storing data from a digital medical modality device 11. The medical data file 13 represents the digital or analog presentation of the processed data from the medical data processor 12 originally obtained from the medical modality device 11.

In one embodiment, the diagnostic healthcare device 10 is a medical imaging device consisting of a medical modality 11, medical imaging processor 12 and medical data file 13. The medical modality 11 produces a set of image data files that comprise a complete diagnostic study. Medical modality 11 generates a image data set and includes, but is not limited to, a diagnostic modality such as computed tomography (CT), magnetic resonance (MR), ultrasound (US) or digital radiography (DR). Medical modality 11 communicates the generated image data set to a medical imaging processor 12. Typically, the medical imaging processor forms a representative output image and also includes imaging information that specifies the characteristics of the modality or other operations. The data is processed by the medical data processor 12 which may include but is not limited to image reconstruction from raw data files. The processed set of image data files are the medical data file 13. One embodiment of the medical data file 13 may be in the form a continuous tone laser image or other hard-copy method of archiving. Another embodiment of the medical data file 13 may be in the production of digital medical information data files that are locally digitally stored, such as in the form of Digital Imaging and Communications in Medicine (DICOM) images sets, a propriety file format or a common computer graphics compression or file format such as Joint Photography Experts Group (JPEG), Tagged Image File Format (TIFF) or wavelet.

In another embodiment, the medical modality 11 of the diagnostic healthcare device 10 is a recording of physical examination, including but not limited to, a portable electrocardiogram recorder having sensing mechanisms for obtaining electrocardiogram readings and electronic hardware and software for digitizing the recorded data.

In yet another embodiment, the medical modality 11 of the diagnostic healthcare device 10 is a device for capturing other visual data, including but not limited to, images of the microscopic slides as seen with a microscope.

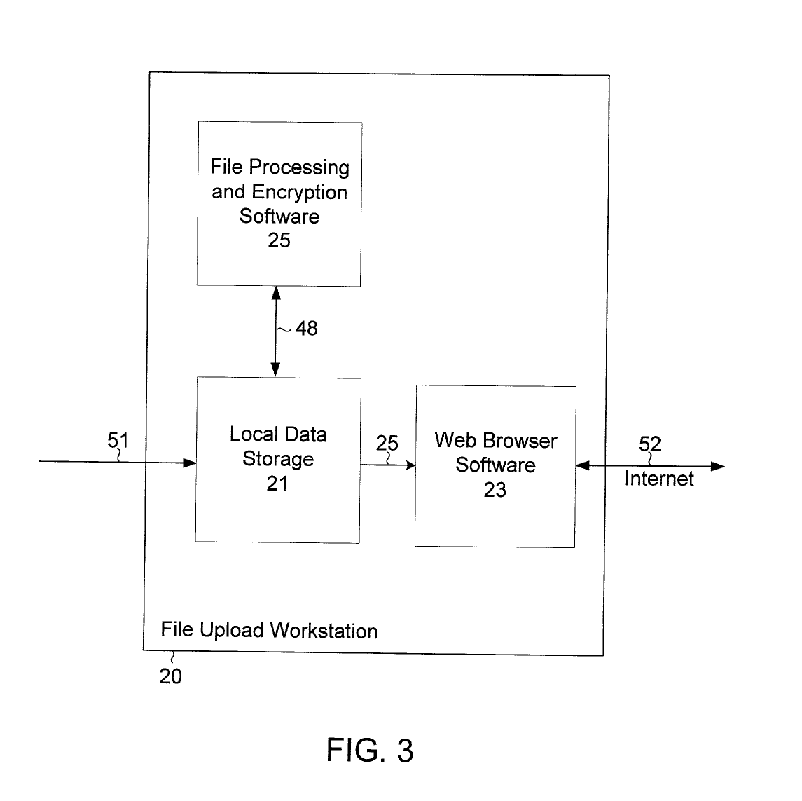

FIG. 3 illustrates a preferred embodiment of the file upload workstation 20 in block diagram form. A file upload workstation 20 may be realized by any one of a variety of available computer system platforms including the Windows platforms, Macintosh platforms, Unix platforms as well as any other platform capable of executing file processing and encryption software 25 and web browser 23 software.

In another embodiment, the File Upload Workstation 20 may execute code for operating a digitization device such as an optical scanner to be used in the digitization of conventional film or paper sources from analog data produced by an analog diagnostic healthcare device 11.

A communications connection 51 allows a file upload workstation 20 to receive data from the diagnostic healthcare device 10. This network may be a local area network (LAN) or a wide area network (WAN). Suitable methods of a communications connection 51 include known analog and/or digital techniques, as well as networking mechanisms that are developed in the future. Many different network protocols can be used to implement a network. These protocols are specialized computer programs that allow computers to communicate across a network. The communication connection 51 may be circuitry for communicating over local area networks, or telephone lines including cellular telephone links, or serial communication links, or parallel communication links, or power line communication links, or radio, cellular radio, so paging or infrared communication links as is appropriate to a particular embodiment.

In the preferred embodiment, the communication network from the file upload workstation 20 to the internet file server 40 is the public internet 52. The internet 52 supports standard internet communication protocols including Hyper-Text Transfer Protocol (HTTP) and HTML, as well as underlying layers including Transmission Control Protocol/Internet Protocol (TCP/IP). The communication paths to the internet 52 may be coaxial communication links, power line communication links, twisted pair communication links, radio frequency communication links, infrared communication links, cellular telephone links, serial communication links, parallel communication links, paging or any combination thereof. The internet 52 connection may be a direct internet connection or a connection to an Internet Service Provider (ISP) that in turn provides internet access.

In one embodiment, a set of digital medical data files 13 produced by medical modality 11 are transferred to the local data storage 21 of a local computer which functions as the file upload workstation 20. The file upload workstation 20 coordinates the transfer of the files to an offsite internet file server 30. The file upload workstation 20 executes, among other things, encryption software 25 which may optionally encrypt the medical data output files 13 prior to transfer to the internet file server 40. The file upload workstation 20 also executes, among other things, web browser software 24 which provides a mechanism for uploading of the medical data files 13 to the internet file server 40.

In one embodiment, the format and contents of the digital medical data file 13 is ultimately unaltered at upon final destination at the remote file download workstation 40. Although the data may be encrypted for the purposes of distribution, the techniques employed may be lossless and reversible. Alternatively, the current invention does provide for the optional irreversible conversion to another format. Conversion to a more accessible format may be desirable in some situations.

In one embodiment, file-level security may be provided. File processing and encryption software 25 located on the file upload workstation 20 may utilize a variety of methods for providing secure access to the digital medical data files and related information originating from the healthcare device 10. Such mechanisms include encryption of the medical data file 13 prior to transfer to the internet file server 30. The medical data file 13 may remain in an encrypted state during transfer to the internet file server 30, during storage on the internet file server 30, and during transfer from the internet file server 30 to the end-user file download workstation 40. The medical data file 13 is decrypted once on the end-user's local storage system on the file download workstation 40.

The file processing and encryption software 25 may use one or more of propriety or open source encryption algorithms, including but not limited to, DES, Triple DES, RC2, RC4, MD4, MD5, Rijndael or Twofish. Symmetric and asymmetric private and public key techniques may be utilized. The encryption function may be incorporated from within the file processing and encryption software 25 or from a third party software or hardware device controlled by the file processing and encryption software 25.

Web browser software 23 may be embodied in a file upload workstation 20. The web browser software may be a stand-alone publicly available software program, such as Microsoft Internet Explorer or Netscape Navigator. The functionality of a web browser, including compliance with internet standards for communication, may also be embodied in a variety of other propriety or specialized software devices designed to emulate the HTTP and File Transfer Protocol (FTP) functionality of a web browser. Such propriety software may provide internet client functions and render web pages.

Various technologies involved are inherent in internet and web technology and enable the communication between a file upload workstation 20 and an internet file server 30 that is independent of the platform that executes web browser software. The web browser software 23 provides the ability to display web pages by generating visual objects including text, images, multimedia objects, and graphical user interface objects. The web browser software 23 allows for a selection device, such as a mouse or other pointing device, that enables a user to select objects and URL links rendered on the display. The web browser software 23 may also include an audio capability that enables rendering of audio information to the user.

A web page is primarily visual data that is intended to be displayed on the monitor of user file upload workstation 20 by web browser software 23. Web pages are generally written in HTML, although other languages are constantly being introduced or refined, such as Active Server Pages (ASP), Java Server Pages (JSP), Cold Fusion, extended Markup Language (XML) and other as yet developed protocols. A web page displayed on the user's screen may contain text, graphics, and links (which are addresses of other web pages.) Other web pages (i.e., those represented by links) may be on the same or on different web servers. A web may contain one or more links that specify additional web pages located elsewhere, for example, on a local communication network or on the internet world wide web. The user can go to these other web pages by clicking on these links using a mouse or other pointing device. This entire system of web pages with links to other web pages on other servers across the world is known as the “World Wide Web”.

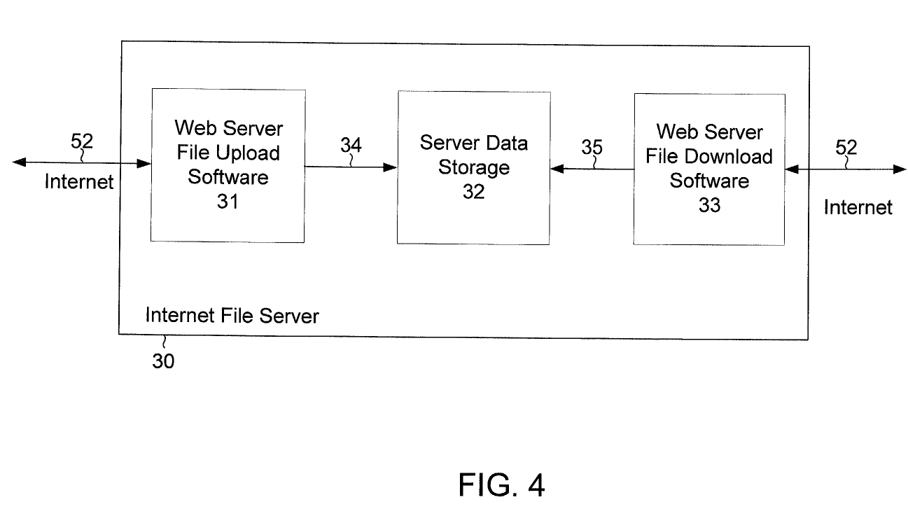

FIG. 4 illustrates a preferred embodiment of the internet file server 30 in block diagram form. The internet file server 30 may be realized by any one of a variety of available computer system platforms including the Windows platforms, Macintosh platforms, Unix platforms as well as any other platform capable of executing web server functions. The internet file server 40 consists of an internet-connected 52 web server file upload software 31, server data storage 32, and web server file download software 33.

In one embodiment, the internet file server 30 is located at an “offsite” or “hosted” environment. An “offsite” environment is one in which the internet 30 file server and associated files, including an a website, are located, managed and physically maintained at a location separate from the diagnostic healthcare device 10 and which does not have a direct or local network connection 51 to the diagnostic healthcare device 10. A “hosted” environment is one in which the file server and associated website are located, managed and physically maintained at a location operated by a third party whose primary business is providing these services to a multiplicity of clients on one or several files servers. The present invention is designed to allow for full functionality on all levels of internet file servers, including the most restrictive environments such as a hosted website running on a Unix-based server platform.

The web server file upload software 31 monitors and services requests for which it has responsibility. When internet file server 30 receives a web page request from a file upload workstation 20 via web browser software 23, it will generate a web page that defines a set of user interface functions for file uploading and send it off across the internet 52 to the requesting web browser software 23. The web server file upload software 31 accesses either a static web page stored on the server storage data 32 or dynamically creates a web page corresponding to the specific request and transmits the page to the file upload workstation 20 via the internet 52. Web browser software 23 on the file upload workstation 20 understands HTML and interprets it and outputs the web page to the display monitor of the file upload workstation 20.

To allow for web-browser or HTML-based file uploading, the internet file server 30 is compliant with RFC-1867 “Form-based File Upload in HTML” specifications as published by the Internet Engineering Task Force (IETF). The RFC-1867 specifications allows for cross-platform and interoperability between the various technologies employed by a web browser software 13 and internet file server 30. Various technologies are available to coordinate file transfers between server and client, ranging from the relatively universal cross-platform protocol Common Gateway Interface (CGI), or interpreted languages such as Practical Extraction and Reporting Language (PERL), JavaScript, Java-based programs and Java Servlets, to relatively platform-restrictive technologies such as ASP, Cold Fusion, Microsoft.net or ActiveX controls.

A variety of methods may be implemented on the internet file server 30 which provide secure transmission, file and server access. Such mechanisms include dynamic public or private key encryption of the digital medical data files and related information transported during uploading and downloading to the internet file server 30, such as provided by the industry-standard Secure Sockets Layer (SSL) by use of HTTPS commands, newer protocols such as IPsec, Virtual Private Networking (VPN), secure File Transfer Protocol (SFTP or FTPS) or other encryption technologies. In addition, access to the internet file server 30 may be password protected and/or require smartcard, biometrical access control or other security hardware device be used at level of a web browser software 23, file upload workstation 20, or file download workstation 40, to enable access to both uploading and downloading. For example, a HTTP command used to request the medical information may be required to include a predetermined password. The internet file server 30 examines the password and either ignores the HTTP command or transfers a reject message to the requesting web client if the password is missing or invalid.

Once the file processing and encryption software 25 has been executed on the file upload workstation 20, a web browser application 23 or functional equivalent is executed on the file upload workstation 20 with network access the internet 52. A user requests a web page by sending a URL across the internet 52 to internet file server 30. A URL is a well known protocol used to address resources on the World Wide Web. A URL contains the complete internet address of a web server plus additional parameters which specify the desired web page. To transmit a set of digital medical data files 13 to the internet file server 30, a healthcare worker at the file upload workstation 20 enters a URL corresponding to the target file location for a specific healthcare device 10 into a web browser 23 or compatible device. In response, the web browser software 23 transfers a command which includes the entered URL over the internet 52. The command used by the web browser software 23 to send the digital medical data file(s) 13 originating from the healthcare device 10 may be an HTTP POST, HTTP PUT or FTP command, or other propriety command.

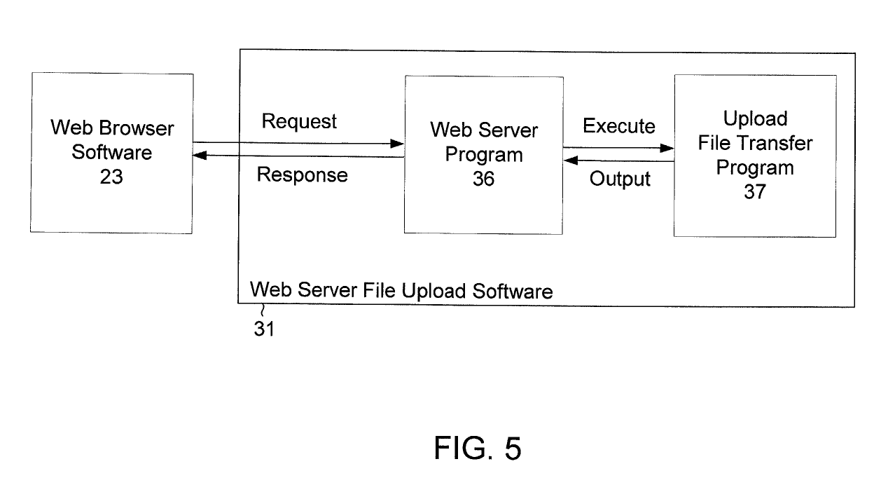

FIG. 5 illustrates a preferred embodiment of a web server file upload software 31 in block diagram form. For the internet file server 30 to receive a set of digital medical data files 13, the internet file server 30 receives the HTTP or FTP request via the internet 52 from the web browser software 23. The web server program 36 recognizes the URL contained therein. In response, the internet file server 30 uploads the digital medical data files 13 by executing a upload file transfer program 37. The web server program 36 responds to the web browser software 23 according to the output of the upload file transfer program 37. File uploading may be performed by a variety of upload file transfer programs 37, including native web browser form-based file uploading mechanisms, as well as the use of, but not limited to, CGI scripts and CGI-derived scripting languages such as PERL or PHP: Hypertext Preprocessor (PHP), or other scripting languages including, but not limited to, Java applets or applications, JavaScript, Java Servlets, ASP components, Cold Fusion or Java Server Pages, ActiveX or related components, XML and related scripts.

One implementation for handling web browser-based file uploading is illustrated by the use of a CGI program as the upload file transfer program 37. Web server file upload software 31 utilizes a web server program 36 and a upload file transfer program 37 “fileupload.cgi” which utilizes the well known CGI server scripting protocol. The example “fileupload.cgi” upload file transfer program 37 is designed specifically to process RFC1867-compliant HTTP POST commands to allow for the uploading a binary file to the web server. The HTTP POST command is sent from the file upload workstation 20 and travels across the internet 52, contacting the internet file server 30 (as specified in the URL). The web server program 36 then processes the command. For example, the web server program 36 may interpret the first parameter “file 1” as the index name for the file and the second parameter “image 1.dcm” as the actual filename by which the file will be stored. The web server application 13 will then pass the parameters (e.g., file1 and image1.dcm) to the upload file transfer program 37 “fileupload.cgi”. The CGI program will then complete the RFC-1867-compliant file upload and save the digital medical data file 13 to the internet file server data storage 32. Additional information may be stored on the server for use in directory listings or a database, such as patient name, medical record number, study type, clinical history or other pertinent information.

The most salient portions of example upload file transfer program 37 is the operation of a web-browser based RFC-1867-compliant file upload program may best be understood by the following example:

An example of a URL generated by the file upload workstation 20 is:

“POST https://www.abcxyz.com/cgi-bin/fileupload.cgi?file=file1&name=image1.dcm” where:

“POST https://” is the standard syntax to tell the web browser that what follows is a web page address and to request that the destination Web server accept the enclosed message body to be transmitted encrypted with SSL over the internet via HTTPS;

“www.abcxyz.com” is the web server address;

“/cgi-bin/fileupload.cgi” tells the web server to execute the CGI program “fileupload.cgi” located in the “/cgi-bin/” folder and pass any remaining part of the URL as parameters;

“?file=file1&name=image1.dcm” instructs the CGI program that the parameter “file” has a value of “file1” and the corresponding parameter “filename” has a value of “image1.dcm”.

An example of a CGI upload file transfer program 37 that completes the file upload to the internet file server is:

open (OUTFILE, “>$fileName”);
print “$fileName<br>”;
while (my $bytesread = read($file, my $buffer, 1024)) {
print OUTFILE $buffer;
}
close (OUTFILE);

One embodiment includes the use of additional client or server-side software while may help the upload file transfer program 37 coordinate the submission and/or processing of file(s) in addition to automating the file transfer. These helper applications may include Java applets or ActiveX controls activated by the web page or browser.

Once a digital medical data file 13 has been successfully uploaded to the server data storage 32 device of an internet file server 30, the digital medical data file 13 is available for download via the public internet 52 to a local data storage device 42 of a file download workstation 40.

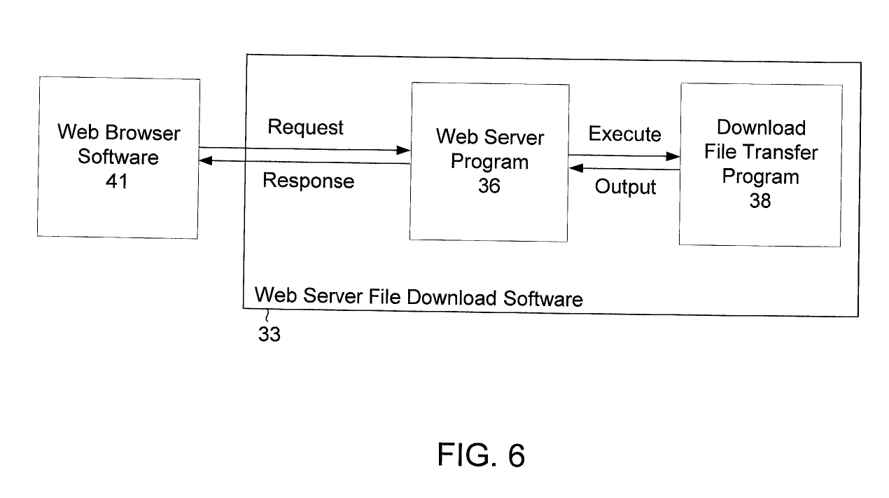

FIG. 6 illustrates a preferred embodiment of a internet file server file download software 33 in block diagram form. The internet file server file download software 33 consists of a web server program 36 and a download file transfer program 38. To initiate the download of digital medical data files 13 from an internet file server 30 to the local data storage device 42 of a file download workstation 40, a user executes web browser software 41 on a file download workstation 40 to access the internet 52 and requests a web page by sending a HTTP or FTP request containing a URL to the web server program 36 located on the internet file server 30. A URL is a well known protocol used to address resources on the World Wide Web. A URL contains the complete internet address of a web server plus additional parameters which specify the desired web page. The web server program 36 interprets the request and executes the appropriate download file transfer program 38. The file download file transfer program 38 then outputs commands to the web server program 36 which control the file download of the digital medical data file 13 from an internet file server 30 to the local data storage device 42 of a file download workstation 40.

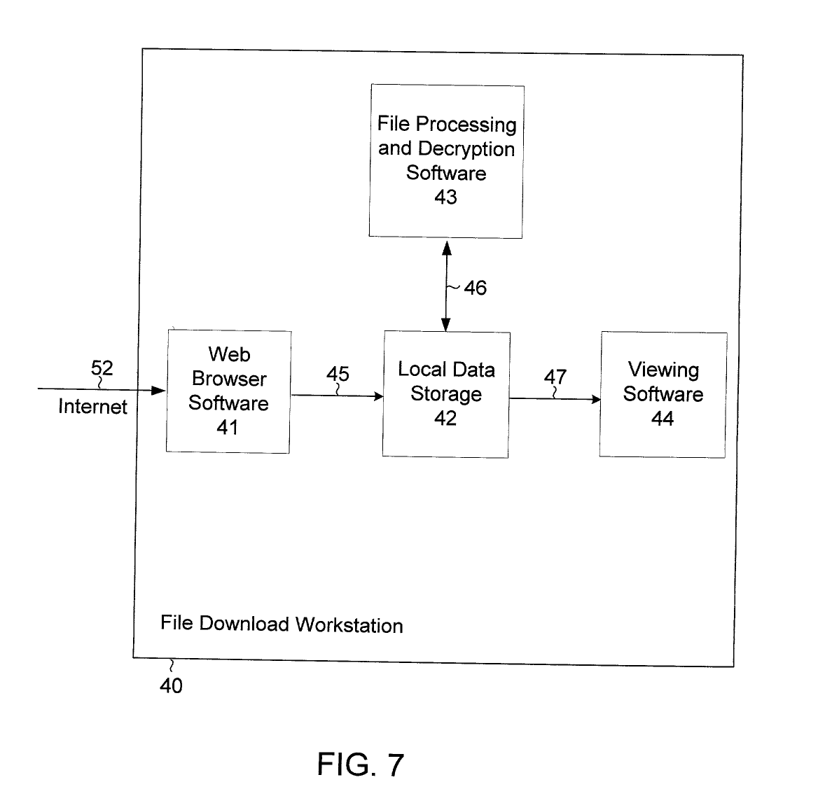

FIG. 7 illustrates a preferred embodiment of the file download workstation 40 in block diagram form. A file download workstation 40 may be realized by any one of a variety of available computer system platforms including the Windows platforms, Macintosh platforms, Unix platforms. The file download workstation 40 consists of an internet connection 52, web browser software 41, local data storage device 42, file processing and decryption software 43 and data viewing software 44. The file download workstation 40 executes, among other things, web browser software 41 which provides a mechanism for initiating and coordinating the downloading of the digital medical data file 13 from the internet file server 40. The file download workstation 40 executes, among other things, file processing and encryption software 43 which may optionally decrypt the digital medical data file 13 after completion of the file download to the local storage device 42 of the file download workstation 40. The digital medical data file 13 may ultimately be reviewed and analyzed by the end-user using appropriate data viewing software 44.

File downloading may be performed by a variety of download file transfer programs 38, including, but not limited to, native web browser HTML, DHTML, HTTP, XML or other file downloading mechanisms, CGI scripts and CGI-derived scripting languages such as PERL or PHP, Java applets or applications, JavaScript, Java Servlets, propriety scripting languages including ASP web pages or ASP components, Cold Fusion or Java Server Pages, ActiveX or related components, or other internet scripting or programming languages.

In the preferred embodiment, the communication network to the file download workstation 40 from the internet file server 30 is the public internet 52. The internet 52 supports standard internet communication protocols including HTTP and HTML, as well as underlying layers including TCP/IP. The communication paths to the internet 52 may be coaxial communication links, power line communication links, twisted pair communication links, radio frequency communication links, infrared communication links, cellular telephone links, serial communication links, parallel communication links, paging or any combination thereof. The internet 52 connection may be a direct internet connection or a connection to an ISP that in turn provides internet access.

Web browser software 41 may be embodied in a file download workstation 40. The web browser software 41 may be a stand-alone publicly available software program, such as Microsoft Internet Explorer or Netscape Navigator. The functionality of a web browser, including compliance with internet standards for communication, may also be embodied in a variety of other propriety or specialized software devices designed to emulate the HTTP and FTP-related functionality of a web browser. Such propriety software may provide internet client functions and render web pages.

The file processing and decryption software 43 may use one or more of propriety, open source or public domain decryption algorithms, including but not limited to, DES, Triple DES, RC2, RC4, MD4, MD5, Rijndael or Twofish. Symmetric and asymmetric private and public key techniques may be utilized. The decryption function may be incorporated from within the file processing and decryption software 43 or from a third party software or hardware device controlled by the file processing and decryption software 43.

In one embodiment, the digital medical data file 13 is downloaded from within web browser software 41 to the general web browser file cache on the file download workstation 40. When file-level encryption is not utilized and when the digital medical data file 13 conforms to common supported file formats, such as JPEG, the digital medical information may be viewed directly from within the native web browser software 41 executed on the file download workstation 40. Non-standard formats, such as DICOM, wavelet or propriety formats, can be viewed from within web browser software 41 utilizing data viewing software 44 executed from within the web browser software 41, such as a specialized ActiveX control, browser plug-in, Java Applet or application. Data encrypted at the file level may first be decrypted within the web browser software 41 by file processing and decryption software 43 and/or data viewing software 44 prior to viewing utilizing specialized software on either the file download workstation 40 computer or on internet file server 30.

An example of a URL which directs web browser software 41 to download a target digital medical data file 13, with a standard file format such as JPEG, to the file download workstation 40 local storage device 43 local file cache directory and directly display the file from within a web browser window is as follows:

“https://www.abcxyz.com/images/image1.jpg” where:

“https://” is the standard syntax to tell the web browser that what follows is a web page to be transmitted encrypted with SSL over the internet via HTTPS;

“www.abcxyz.com” is the web server address; and

“/images/image1.jpg” tells the web server to retrieve and display the file “image1.jpg” which is located in the “images” folder.

One embodiment includes the use of additional downloadable secondary client or server-side software programs which may assist the download file transfer program 38 to coordinate the submission and/or processing of file(s), and may automate the file transfer. Helper applications may include JavaScripts, Java applications, applets or servlets, CGI or related programs, or ActiveX controls activated by the web page or browser. The use of such downloadable software facilitates the selection and/or display of multiple or selected files, and may also provide database functionality including, but not limited to, DICOM-compliant file management features.

An example of a CGI program which directs web browser software 41 to download a target digital medical data file 13, with a standard file format such as JPEG, to the file download workstation 40 local storage device 43 local file cache directory and directly display the file from within a web browser window is as follows:

read(STDIN,$temp,$ENV{‘CONTENT_LENGTH’});

@pairs=split(/&/,$temp);
foreach $item(@pairs) {

($key,$content)=split (/=/,$item,2);
$content=˜tr/+//;
$content=˜s/%(..)/pack(“c”,hex($1))/ge;
$fields{$key}=$content;

}
print “Content-type: image/jpeg\n\n”;
open IMAGE, $fields{‘filename’};
print <IMAGE>;
close IMAGE;

In another embodiment, the digital medical data file 13 is directly downloaded as a binary file to the local data storage device 42 of the file download workstation 40. The digital medical data file 13 can be subsequently reviewed from within web browser software 41 or data viewing software 44. When file-level encryption is not utilized and when the digital medical data file 13 conforms to common formats, such as JPEG, the digital medical information may be viewed directly from within web browser software 41 executed on the file download workstation 40. Non-standard formats, such as DICOM, can be viewed from within web browser software 41 utilizing specialized software on either the file download workstation 40 computer or on internet file server 30. Data encrypted at the file level must first be decrypted prior to viewing utilizing specialized software on either the file download workstation 40 computer or on internet file server 30.

One embodiment includes the use of additional client or server-side software while may help the download file transfer program 38 coordinate the submission and/or processing of file(s) in addition to automating the file transfer. These helper applications may include Java applets or ActiveX controls activated by the web page or browser. One implementation for handling web browser-based binary file downloading is illustrated by the use of a Java applet functioning as the primary download file transfer program 38 which is imbedded in a HTML web page.

An example of a URL generated by the file download workstation 40 that calls for the downloading of the file download web page is:

“https://www.abcxyz.com/files/filedownload.html” where:

“https://” is the standard syntax to tell the web browser that what follows is a web page to be transmitted encrypted with SSL over the internet via HTTPS;

“www.abcxyz.com” is the web server address; and

“/files/download.html” tells the web server to send the web page “filedownload.html” located in the “files” folder.

In one embodiment, upon loading of a file download web page, a JavaScript is automatically loaded which calls a Java applet which initiates, coordinates and/or performs the file download. For example, a Java applet “FileDownload” may function as the download file transfer program 38 for downloading a medical data file 13 “image1.dcm”, located in directory “images” function on the internet file server data storage 33. The Java applet may be automatically called when the appropriate web page is loaded by the following JavaScript example:

<SCRIPT language=“JavaScript”>
<!--
function waitForInit( )
{

var applet = document.FileDownload;
if (applet.hasInitialized( ))
{

document.FileDownload.download(“\images\image1.dcm”);

}
else

window.setTimeout(‘waitForInit( )’,200);

}
//-->
</SCRIPT>

The above JavaScript program is automatically loaded when the web page is loaded by use of the following code:

<BODY onLoad=“waitForInit( );”>

Once a digital medical data file 13 has been successfully downloaded to the local data storage device 42 of the file upload workstation 40, it can be decrypted by the file processing and decryption software 43 of the file download workstation 40 if received in an encrypted state. The digital medical data file 13 can then be reviewed and analyzed by data viewing software 44. Data viewing software 44 may be in the form of a propriety or third-party viewing and/or analysis software program according to the type of data file.

A doctor, nurse, or other healthcare worker located anywhere with internet access, such as another physical location, hospital, clinic or from their home, may use a web browser 41 located on a file download workstation 40 to access medical data output files 13 originating in a hospital or clinic.

As to a further discussion of the manner of usage and operation of the present invention, the same should be apparent from the above description. Accordingly, no further discussion relating to the manner of usage and operation will be provided.

The foregoing detailed description of the present invention is provided for the purposes of illustration and is not intended to be exhaustive or to limit the invention to the precise embodiment disclosed, but on the contrary, it is the invention as defined by the appended claims.

What is claimed is:

1. A method for secure distribution of digital healthcare data using an offsite internet file server, comprising the steps of:
a) creating a digital medical data file representative of an analog or digital medical study produced by a diagnostic healthcare device;
b) transmitting said digital medical data file to a local client machine communicatively coupled to said diagnostic healthcare device and the internet;
c) transmitting said digital medical data file over the internet from said local client machine to a remote internet file server communicatively coupled to the internet in response to a command signal from said local client machine;
d) storing said digital medical data file on a server storage data device on said remote internet file server; and
e) transmitting said digital medical data file over the internet from said remote internet file server to a remote client machine communicatively coupled to the internet in response to a command signal from said remote client machine.

2. The method of claim 1, further comprising the step of said local client machine encrypting said digital medical data file prior to transmission over the internet.

3. The method of claim 1, wherein a communications link between said local client machine and said remote internet file server uses a uniform resource locator or internet protocol number.

4. The method of claim 1, wherein the step of transmitting said digital medical data file over the internet is performed if the transfer command to said remote internet file server includes information confirming user access privileges.

5. The method of claim 1, wherein the step of transmitting said digital medical data file over the internet is performed using a 1 protocol providing authentication of said local client machine or said remote internet file server.

6. The method of claim 1, wherein the step of transmitting said digital medical data file over the internet is performed using a communications protocol providing in-transit encryption of said digital medical data file to said remote internet file server.

7. The method of claim 1, wherein said remote internet file server further comprises:
a) a web server that generates a web page wherein said web page provides a set of user interface functions related to file transmission, display and maintenance;
b) first means for said local internet file server for receiving said digital medical data files from said remote client machine over the internet;
c) second means for said remote internet file server for transmitting said digital medical data files from said remote internet file server to said remote client machine.

8. The method of claim 7, wherein said first means further comprises:
a) transmitting client file uploading code from said remote internet file server to said local client machine if said client file uploading code does not exist on said local client machine;
b) executing said client file uploading code on local client machine to establish a communications channel between said local client machine and remote internet file server;
c) executing remote internet file server file uploading code to provide for acceptance of file upload from said local client machine to said remote internet file server.

9. The method of claim 7, wherein said second means further comprises:
d) transmitting client file downloading code from said remote internet file server to said remote client machine if said client file downloading code does not exist on said remote client machine;
e) executing said client file downloading code on remote client machine to establish a communications channel between said remote client machine and remote internet file server;
f) executing remote internet file server file downloading code to provide for acceptance of file download from said remote internet file server to said remote client machine.

10. The healthcare device of claim 1, wherein the medical information comprises a set of measurement data generated by the device-specific hardware of the healthcare device.

11. The healthcare device of claim 10, wherein the medical information further comprises a patient identifier corresponding to the measurement data.

12. The healthcare device of claim 10, wherein the medical information further comprises a time-stamp corresponding to the measurement data.

13. The healthcare device of claim 10, wherein the measurement data comprises a set of computed tomographic imaging data.

14. The healthcare device of claim 10, wherein the measurement data comprises a set of magnetic resonance imaging data.

15. The healthcare device of claim 10, wherein the measurement data comprises a set of ultrasound data.

16. The healthcare device of claim 10, wherein the measurement data comprises a set of radiography data.

17. The healthcare device of claim 10, wherein the measurement data comprises a set of fluoroscopy data.

18. The healthcare device of claim 10, wherein the measurement data comprises a set of angiography data.

19. The healthcare device of claim 10, wherein the measurement data comprises a set of nuclear medicine data.

20. The healthcare device of claim 10, wherein the measurement data comprises a set of blood pressure data.

21. The healthcare device of claim 10, wherein the measurement data comprises a set of pathology data.

22. The healthcare device of claim 10, wherein the measurement data comprises a set of blood analysis data.

23. The healthcare device of claim 10, wherein the measurement data comprises a set of electrocardiogram recorder data.

24. The healthcare device of claim 10, wherein the measurement data comprises a set of lung efficiency data.

25. The healthcare device of claim 10, wherein the measurement data comprises a set of blood glucose data.

26. The healthcare device of claim 10, wherein the measurement data comprises a set of blood alcohol data.

27. The healthcare device of claim 10, wherein the measurement data comprises a set of fecal blood data.

28. The healthcare device of claim 10, wherein the measurement data comprises a set of body weight data.

29. The digital medical data file of claim 1, wherein the data comprises a set of digitized patient clinical records.
